(19) United States
(12) Patent Application Publication
(10) Pub. No.: US 2015/0275456 A1
(43) Pub. Date: Oct. 1, 2015

(54) PILE HAMMER

(71) Applicant: DELMAG GmbH & Co. KG, Niedernberg (DE)

(72) Inventors: Matthias HEICHEL, Aschaffenburg (DE); Leopold JERCH, Babenhausen (DE)

(73) Assignee: DELMAG GmbH & Co. KG, Niedernberg (DE)

(21) Appl. No.: 14/619,269

(22) Filed: Feb. 11, 2015

(30) Foreign Application Priority Data
Mar. 28, 2014 (EP) 14162392.6

(51) Int. Cl. E02D 7/12; B25D 17/26

(52) U.S. Cl. CPC E02D 7/125; B25D 17/26

(57) ABSTRACT

A pile hammer includes a cylinder, a piston displaceably guided in the cylinder, and a striker displaceably guided in the cylinder. The striker is disposed underneath the piston in the operating position of the pile hammer. A combustion chamber is delimited axially by a face surface of the striker that lies in the interior of the cylinder and by a face surface of the piston. Using at least one fuel feed device a predetermined amount of fuel can be introduced into the combustion chamber during each work cycle. At least one lubricant dispenser for conveying a lubricant between piston and cylinder is set up in such a manner that conveying of lubricant is brought about via the impact shock of the piston.

### CROSS REFERENCE TO RELATED APPLICATIONS

Applicant claims priority under 35 U.S.C. §119 of European Application No. 14162392.6 filed Mar. 28, 2014, the disclosure of which is incorporated by reference.

### BACKGROUND OF THE INVENTION

1. Field of the Invention

The invention relates to a pile hammer comprising a cylinder, a piston displaceably guided in the cylinder, and a striker displaceably guided in the cylinder.

2. Description of the Related Art

Such pile hammers, which are regularly also called diesel hammers or diesel pile drivers, are particularly used in foundation work in the construction industry. The pile hammers are used for driving posts of all kinds, such as concrete pillars, iron beams, sheet pile wall elements or the like into a construction ground.

To start such a pile hammer, the piston is pulled upward using a disengagement apparatus, and released at a specific height, thereupon dropping downward under the effect of gravity. As it drops, the piston activates a fuel pump, by way of which fuel, particularly diesel oil, is supplied to one or more injection nozzles, which inject the fuel into the combustion chamber of the cylinder. The air situated in the combustion chamber of the cylinder is compressed as the piston drops, and thereby heated so that the fuel/air mixture present in the working chamber is ignited, whereupon it combusts in the manner of an explosion. The explosion energy released during this process accelerates the piston back upward for a new work cycle, on the one hand; on the other hand, the material being pile-driven is driven into the ground.

To minimize the friction between cylinder and piston, a constant amount of lubricant is continuously introduced by way of a lubricant pump. In this connection, excess and combusted lubricant flows directly into the combustion chamber of the cylinder. As a result, the combustion process of the fuel is impaired, particularly if there is a great return flow of lubricant, and significant smoke and soot formation of the pile hammer occurs. This effect occurs above all in the partial-load range of the pile hammer.

### SUMMARY OF THE INVENTION

The invention wishes to provide a remedy for this situation. The invention is based on the task of making available a pile hammer in which the amount of lubricant that flows into the combustion chamber is reduced, particularly in the partial-load range. According to the invention, this task is accomplished by means of a pile hammer including a cylinder, a piston displaceably guided in the cylinder, and a striker displaceably guided in the cylinder. The striker is disposed underneath the piston in the operating position of the pile hammer. A combustion chamber is delimited axially by a face surface of the striker that lies in the interior of the cylinder and a face surface of the piston. Using at least one fuel feed device, a predetermined amount of fuel can be introduced into the combustion chamber during each work cycle. At least one lubricant dispenser for conveying a lubricant between piston and cylinder is set up in such a manner that conveying of lubricant is brought about by means of the impact shock of the piston.

With the invention, a pile hammer is made available, in which the amount of lubricant that flows into the combustion chamber is reduced, particularly in the partial-load range. Supplying of lubricant is brought about via the impact shock of the piston. Because the lubricant dispenser is set up so that conveying of the lubricant is brought about via the impact shock of the piston, adaptation of the lubricant amount to the operating states of the pile hammer, in each instance, is achieved.

In a further development of the invention, the lubricant dispenser has a control module that is connected with a sensor for detecting the jump height of the piston and/or the impact count of the piston. As a result, metering of the lubricant in accordance with the impact shock, which is dependent on the impact count and on the jump height of the piston, is made possible.

In an alternative further development of the invention, the lubricant dispenser comprises a piston that is disposed in a housing and delimits a lubricant chamber for accommodating the lubricant, in which chamber a lubricant line ends and which chamber is biased by way of a spring element, whereby the lubricant line is closed off by way of a valve that can be activated by way of an inertia mass. As a result, simple mechanical and, at the same time, reliable regulation of the lubricant amount is achieved. At every impact of the piston of the pile hammer, the inertia mass in the lubricant dispenser is moved, thereby activating the valve, thereby pressing the lubricant, which stands under pressure by way of the biased piston, through the lubricant line.

Metering of the lubricant amount is therefore dependent on the impact energy of the piston of the pile hammer. In the case of a hard impact (high impact energy), the inertia mass of the lubricant dispenser is accelerated more strongly and therefore travels a greater distance, thereby bringing about a longer open time of the valve. As a result, a greater amount of lubricant is pressed through the lubricant line. In the case of a softer impact of the piston, the inertia mass is accelerated only slightly and therefore travels only a shorter distance, thereby bringing about a shorter open time of the valve. In this case, only a small amount of lubricant is pressed through the lubricant line.

In an embodiment of the invention, a slide bearing bushing is disposed in the cylinder, at its top, in which bushing the piston is guided. As a result, the amount of lubricant required for lubrication is reduced, thereby simultaneously minimizing the amount of non-combusted lubricant that gets into the environment.

In a further embodiment of the invention, an end piece is disposed on the cylinder, at the end side. This piece is elastically connected with the cylinder and forms a capture groove for the piston, which has a step for this purpose. The slide bearing bushing is disposed in the cylinder so as to lie against this capture groove. As a result, the piston is prevented from being accelerated out of the cylinder in the event that a mixture of fuel and lubricant/air not combusted during a work cycle causes excessive energy to act on the piston during the subsequent work cycle. If the piston is moved too far out of the cylinder due to excessive energy, the step of the piston hits against the capture groove formed by the end ring, thereby holding the piston back. Because of the elastic connection of the end ring with the cylinder, part of the movement energy of the piston is absorbed. In this connection, the piston is preferably provided with a capture piston ring, by means of which the step is formed.

In a further embodiment of the invention, the elastic connection of the end ring with the cylinder comprises an arrangement of friction springs. In this way, particularly effective absorption of movement energy of the piston is achieved.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic representation of a pile hammer in the form of a diesel hammer;

FIG. 2 is a schematic representation of the piston end impact region of the pile hammer from FIG. 1, with the flange connection of the end ring indicated;

FIG. 3 is a detail representation of Detail III from FIG. 2; and

FIG. 4 is a schematic representation of the lubricant dispenser of the pile hammer from FIG. 1.

### DETAILED DESCRIPTION OF PREFERRED EMBODIMENTS

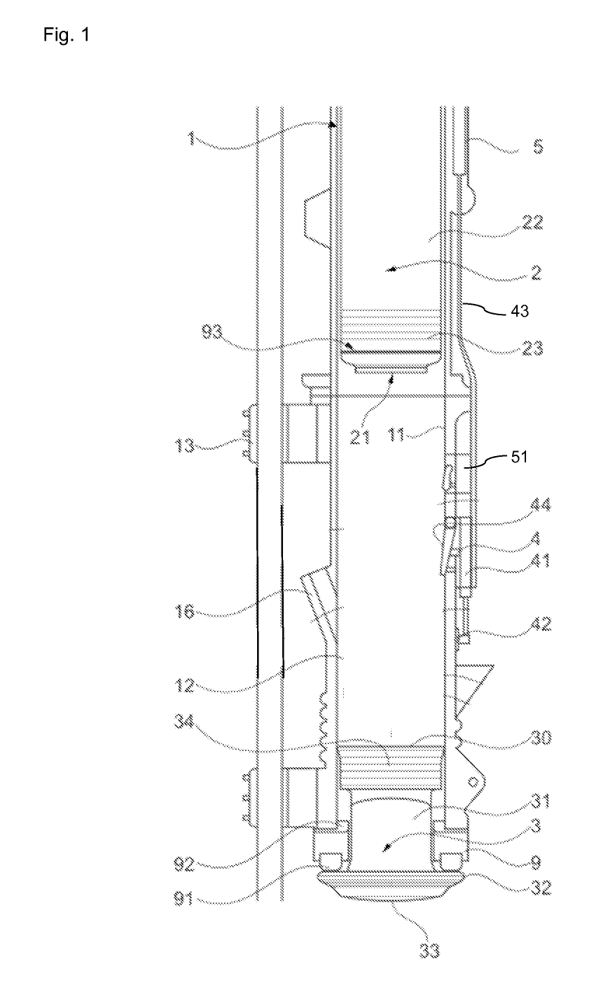

Referring now in detail to the drawings, the pile hammer shown in FIG. 1 selected as an exemplary embodiment comprises a cylinder 1 that is open on both sides, and regularly can have a length of 3 to 8 meters and a diameter of 0.2 to 1.5 meters. A piston 2 is displaceably disposed in the cylinder 1. A striker 3 coaxial to the piston 2 engages into the open lower end of the cylinder 1, in displaceable manner. A ring-shaped bearing unit 9 is attached at the lower end of the cylinder 1, in which unit a central shaft section 31 of the striker 3 is guided in tight and displaceable manner. Central shaft section 31 has an outside diameter that is reduced as compared with the inside diameter of the cylinder 1. The pile hammer is mounted so as to be vertically displaceable along a leader, by way of guide jaws 13 disposed on the cylinder 1.

A striker plate 32 that lies below the cylinder 1 is formed onto the lower end of the shaft section 31, the lower convex delimitation surface 33 of which plate, directed outward, interacts with the upper end of a material to be pile-driven, for example a sheet pile wall element, during operation.

A piston section 34 having multiple circumferential sealing rings, spaced apart from one another axially, which run on the inner mantle surface 11 of the cylinder 1, is formed onto the upper end of the shaft section 31 of the striker 3. A combustion chamber 12 is delimited by the top of the piston section 34 of the striker 3, together with the underside of the piston 2 as well as the inner mantle surface 11 of the cylinder 1. The face surface of the striker 3 that faces the combustion chamber 12 of the cylinder 1 is ground to be planar with a flat fuel bowl 30.

A damping ring 91 is disposed between the striker plate 32 of the striker 3 and the bearing unit 9 of the cylinder 1. A further damping ring 92 is disposed adjacent to the bearing unit 9, between the top of the bearing unit 9 and the underside of the piston section 34 of the striker 3.

A lower working end 23 of the piston 2, provided with circumferential sealing rings 93 spaced apart from one another axially, runs in the interior of the piston 1, above the striker 3. The lower free face surface 21 of the piston 2, which is ground to be planar, is set off by a radially circumferential step.

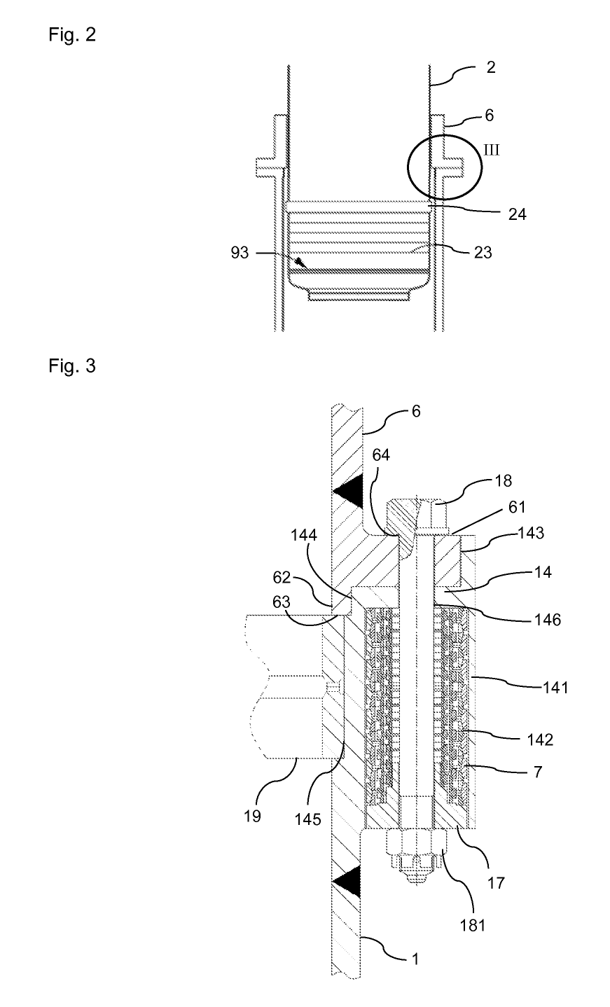

A mass section 22 that extends into the upper section of the cylinder 1 is formed onto the lower working end 23 of the piston 2. A capture piston ring 24 (see FIG. 2) is disposed on the piston 2 at the lower end of the mass section 22, the outside diameter of which ring projects beyond the outside diameter of the piston 2 in this region.

An injection apparatus 4 is disposed on the circumference wall of the cylinder 1, which apparatus comprises a fuel pump 41 that is connected with the injection nozzle 42 by way of a line 43. The inlet of the fuel pump 41 is supplied with diesel oil by way of a fuel tank 5.

The fuel pump 41, connected with the fuel tank 5 by way of the line 43, has a biased pump lever 44 that projects into the interior of the cylinder 1, by way of which lever the pump is driven as the dropping piston 2 moves past it. The injection nozzle 42 is configured and oriented in such a manner that the fuel emitted is sprayed approximately onto the center of the face surface of the striker 3 in an essentially cohesive stream.

Furthermore, a lubricant dispenser 51 is disposed on the cylinder 1, which dispenser is connected with lubricant nozzles distributed in the circumference direction of the cylinder 1. The lubricant is dispensed between the piston 2 and the inner mantle surface 11 of the cylinder 1 by means of the lubricant nozzles.

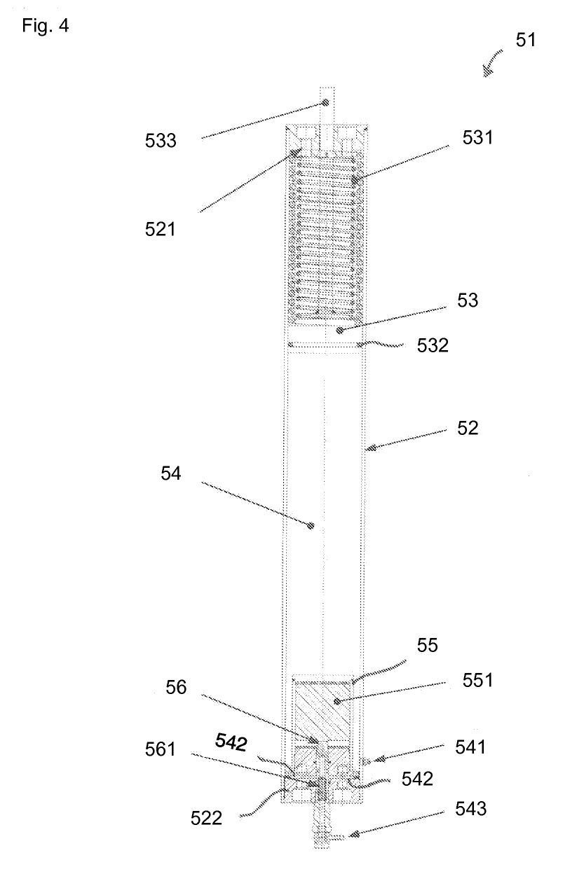

As shown in FIG. 4, the lubricant dispenser 51 comprises a housing 52 that is provided with attachment threads 521 at its upper end, for attaching it to the outer wall of the cylinder 1. A piston 53 is disposed within the housing 52, which piston is biased by way of a spring 531 and sealed off, with regard to the inner wall of the housing 52, by means of a seal 532. A fill level monitoring rod 533 is formed onto the piston 53, which rod penetrates the spring as well as the cover side of the housing 52. The piston 53 delimits a lubricant chamber 54 that can be filled with lubricant by way of a filling connector 541. Two lubricant lines 542 are disposed in the bottom piece 522 of the housing 52, which lines connect the lubricant chamber 54 with the lubricant exit 543 on the bottom side.

An inner housing 55 is attached within the housing 52, on the bottom piece 522, which housing accommodates an inertia mass 551. The inertia mass 551 is connected with a valve 56 that is disposed in the lubricant exit 543 and biased by way of a spring 561. When the valve 56 is activated, the connection between the lubricant lines 542 and the lubricant exit 543 is released, thereby pressing the lubricant in the lubricant space or chamber 54, to which lubricant pressure is applied by way of the biased piston 53, through the lubricant exit 543. After the lubricant has exited, the piston 53 drops within the housing 2, thereby lowering the oil level monitoring rod 533. As a result, a reduction in filling level can be seen optically, on the basis of the part of the filling level monitoring rod 533 that projects out of the housing. Refilling of the lubricant chamber 54 with lubricant takes place by way of the filling connector 541.

At its open end that lies opposite the striker 3, a circumferential flange part 14 shown in FIG. 3 that extends radially outward is disposed on the cylinder 1. The flange part 14 ends in a cylinder piece 141 that lies orthogonal to it, by means of which a flange accommodation 143 for the flange 61 of the end ring 6 is formed on one side of the spring accommodation 142 as well as on the opposite side. Furthermore, a circumferential groove 144 for accommodating the circumferential projection 62 of the end ring 6 is introduced into the inner wall of the cylinder 1 at the level of the flange part 14. Furthermore, a bearing groove 145 is disposed below the groove 144, in the inner wall of the cylinder 1, which groove accommodates a slide bearing bushing 19, which lies against the projection 62 of the end ring 6.

The end ring 6 is configured essentially as a hollow cylinder and has a flange 61 that projects radially outward at a distance from its end facing the cylinder 1, thereby forming a circumferential projection 62 below the flange 61. The projection 62 makes contact in the groove 144 of the cylinder 1, whereby the projection 62 projects inward beyond the groove 144, thereby in turn forming a capture groove 63 against which the slide bearing bushing 19 lies. Bores 64, 146 that correspond with one another, in each instance, are introduced into the circumferential flange 61 of the end ring 6 as well as into the circumferential flange part 14 of the cylinder 1, through which bores the screws 18 are passed.

A ring-shaped friction spring package 7 is disposed in the flange accommodation 143 formed by the flange part 14 as well as the cylinder piece 141, which package lies on a carriage 17 on the side opposite the flange part 14, which carriage is disposed so as to be displaceable between the outer mantle of the cylinder 1 and the inner mantle of the cylinder piece 141. The friction spring package 7 as well as the carriage 17 are provided with bores that correspond to the bores 146 of the flange part 14 and align with them, in which bores screws 18 are guided. A nut 181 is screwed onto each of the screws 18, by way of which the carriage 17 is biased against the friction spring package 7, which lies against the flange part 14.

The pile hammer described above works as follows: In the starting state, the piston 2 is raised into an upper position by way of a disengagement apparatus—not shown. After disengagement of the piston 2, the piston 2 falls downward under the effect of gravity, closes the working connectors 16, and activates the pump lever 44 of the injection apparatus 4 with its face surface 21, thereby causing the injection nozzle 42 to spray fuel onto the fuel bowl 30 of the striker 3. Here, an ignitable mixture of fuel droplets and air is formed by means of impact atomization. When the piston 2 impacts the striker 3, a force directed downward is exerted on the material to be pile-driven, by means of and by way of the striker 3, which force drives the material to be pile-driven further into the ground. At the same time, the shock brought about by the impact of the piston 2 on the striker 3 moves the inertia mass 551 in the inner housing 55 against the valve 56 that is biased in the closed position by way of the spring 561, thereby causing this valve to be opened. In this connection, the duration of opening of the valve 56 is dependent on the intensity of the impact of the piston 2 on the striker 3. The bias of the spring 561 is set in such a manner that the required minimum amount of lubricant to be supplied is guaranteed.

During the subsequent upward movement of the piston 2, triggered by the explosion-like combustion of the fuel, the piston releases the working connectors 16 again, thereby causing the combustion gases to relax and to flow away by way of the working connectors 16. The piston 2 is now accelerated further upward, drawing fresh air in through the working connectors 16, until it has reached its upper end position and the work cycle, as described, is repeated.

In the event that combustion of the fuel took place only partially during the above-mentioned work cycle, an excessive amount of fuel, possibly supplemented with excess lubricant oil, is available for the subsequent combustion process. As a result of the subsequent explosion-like combustion of the excessive fuel, the piston is accelerated upward with excessive energy, thereby moving it beyond the upper position. In this connection, the capture piston ring 24 makes contact with the slide bearing bushing 19, and, with the bushing, with the capture groove 63. As a result, the end ring 6 is torn along upward, with the screws 18 passed through the bores 146 of the flange part 14. By way of the screws 18 with the nuts 181 disposed on them, the carriage 17 is drawn against the friction spring package 7, which absorbs a large part of the kinetic energy and converts it to heat energy. By way of the reset forces of the friction spring package 7, the screws 18 and, with them, the end ring 6 are moved back into their original position, whereupon the captured piston 2 drops downward for the next work cycle, under the effect of gravity.

In a further embodiment, not shown in the drawings, a sensor for detecting the jump height is disposed on the outside of the cylinder 1, which sensor is connected with a control device, by way of which metered supply of lubricant takes place on the basis of the data detected by the sensor.

Although only a few embodiments of the present invention have been shown and described, it is to be understood that many changes and modifications may be made thereunto without departing from the spirit and scope of the invention.

What is claimed is:

1. A pile hammer comprising:
(a) a cylinder having an interior;
(b) a piston displaceably guided in the cylinder and having a piston face surface;
(c) a striker displaceably guided in the cylinder and disposed underneath the piston in an operating position, said striker having a striker face surface lying in the interior of the cylinder;
(d) a combustion chamber delimited axially by the striker face surface and by the piston face surface;
(e) at least one fuel feed device for introduction of a predetermined amount of fuel into the combustion chamber during each work cycle; and
(f) at least one lubricant dispenser for conveying a lubricant between the piston and the cylinder;
wherein the at least one lubricant dispenser is set up so that conveying of the lubricant is brought about via an impact shock of the piston.

2. The pile hammer according to claim 1, wherein the at least one lubricant dispenser is disposed on an outside portion of the cylinder.

3. The pile hammer according to claim 1, wherein the at least one lubricant dispenser has a control module that is connected with a sensor for detecting at least one of a jump height of the piston and an impact count of the piston.

4. The pile hammer according to claim 1, wherein the at least one lubricant dispenser comprises a piston that is disposed in a housing and delimits a lubricant chamber for accommodating the lubricant, wherein a lubricant line ends in the lubricant chamber and the lubricant chamber is biased by way of a spring element.

5. The pile hammer according to claim 1, further comprising a slide bearing bushing disposed in the cylinder, at a top portion of the cylinder, wherein the piston is guided in the slide bearing bushing.

6. The pile hammer according to claim 5, further comprising an end ring disposed on the cylinder, at an end side, wherein the end ring is elastically connected with the cylinder and forms a capture groove for the piston, wherein the piston has a step for forming the capture groove, and wherein the slide bearing bushing is disposed in the cylinder so as to lie against the capture groove.

7. The pile hammer according to claim 6, wherein the piston is provided with a capture piston ring that is formed by the step.

8. The pile hammer according to claim 6, wherein an arrangement of friction springs elastically connects the end ring with the cylinder.
